(19) United States
(12) Patent Application Publication
(10) Pub. No.: US 2012/0169569 A1
(43) Pub. Date: Jul. 5, 2012

(54) INTEGRATED ANTENNA ACTIVITY MONITOR SYSTEM AND METHOD

(75) Inventor: GUY P. ROBERTS, POTOMAC, MD (US)

(73) Assignee: SYMBOL TECHNOLOGIES, INC., HOLTSVILLE, NY (US)

(21) Appl. No.: 12/980,977

(22) Filed: Dec. 29, 2010

(51) Int. Cl. H01Q 23/00

(52) U.S. Cl. 343/894

(57) ABSTRACT

The present disclosure provides an integrated antenna activity monitor system and method that provides an integrated activity indicator for the antenna by tapping a portion of the radio frequency (RF) energy from the antenna and utilizing the RF energy to drive the integrated activity indicator. In an exemplary embodiment, the integrated activity indicator circuit comprises an impedance matching network, a high-frequency rectifier circuit, and a light emitting diode. The impedance matching network is coupled to an antenna feed of the antenna, and configured to tap a portion of radio frequency energy from the antenna feed. The high-frequency rectifier circuit is coupled to the impedance matching network, and the light emitting diode coupled to an output of the high-frequency rectifier circuit.

### FIELD OF THE INVENTION

The present invention relates generally to a wireless antenna and circuit integrated therein. More particularly, the present invention relates to an integrated antenna activity monitor system and method providing an integrated activity indicator for an antenna.

### BACKGROUND OF THE INVENTION

An antenna is a transducer that transmits and/or receives electromagnetic waves. In other words, antennas convert electromagnetic radiation into electric current, or vice versa. Antennas generally deal in the transmission and reception of radio waves, and are a necessary part of all radio equipment. Antennas may be used in a variety of systems such as broadcasting, point-to-point radio communication, wireless local area network (WLAN), cell phones, radar, radio frequency identification (RFID), and the like. In an exemplary embodiment, a typical RFID deployment may utilize a plurality of fixed antennas connected to one or more RFID interrogators/readers. For example, RFID interrogators may use the antennas to monitor a choke point in a facility, such as a warehouse or manufacturing facility, through which tagged objects pass and tracking data is collected. Optimum reliability of such systems and methods is contingent on the correct operation of the interrogators, the antennas, and the connections therebetween. Conventional systems and methods provide mechanisms to indicate RFID antenna or interrogator status at the antenna using direct current (DC) or alternating current (AC) voltages superposed on the antenna cable. While such a configuration can certainly be made to perform reliably as an indicator of RF activity, it requires significantly more circuitry and an external source of power. In addition, the conventional systems and methods also rely on information from an external agent to determine the level of RF activity at the antennas.

### BRIEF DESCRIPTION OF THE DRAWINGS

The present invention is illustrated and described herein with reference to the various drawings, in which like reference numbers denote like system components, respectively, and in which:

FIG. 1 is a diagram of an installation of a typical embodiment of an ultra high frequency (UHF) RFID system;

FIG. 2 is a circuit diagram of an exemplary implementation of an integrated activity indicator in the antenna; and

FIG. 3 is a circuit diagram of an exemplary implementation of an impedance matching network in the integrated activity indicator of FIG. 2.

### DETAILED DESCRIPTION OF THE INVENTION

In various exemplary embodiments, the present invention provides an integrated antenna activity monitor system and method that provides an activity indicator integrated within an antenna configured to tap off a small portion of the radio frequency (RF) energy from the antenna and utilizing the RF energy to drive the integrated activity indicator. Thus, the present invention provides a quick check of antenna operation at a low cost. The antenna may be configured to operate in a variety of applications including, but not limited to, broadcasting, point-to-point radio communication, WLAN, cell phones, radar, RFID, and the like. The present invention may be suitable for integration within a wide range of antennas used in commercial and industrial applications and has the potential to remove a lot of guesswork in the setup, troubleshooting, and long term maintenance of installations, particularly for complex systems.

In an exemplary embodiment, the integrated activity indicator comprises an impedance matching network, a high-frequency rectifier circuit, and a light emitting diode (LED). The impedance matching network is coupled to an antenna feed of the antenna and configured to tap a portion of RF energy from the antenna feed. The high-frequency rectifier circuit is coupled to the impedance matching network, and the LED is coupled to an output of the high-frequency rectifier circuit. The impedance matching network may comprise a high impedance parallel connection at the antenna feed and a low output impedance that is matched to a voltage doubler rectifier that supplies current to the LED.

The impedance matching network may comprise inductors and capacitors. For example, the impedance matching network may comprise an inductor in parallel to the antenna feed of the antenna, and a capacitor connected to the high-frequency rectifier circuit. Optionally, the impedance matching network may comprise a directional coupler. Optionally, the impedance matching network and the high-frequency rectifier circuit may be disposed on a circuit board in a vicinity of the antenna feed, and wherein the LED may be physically remote from the antenna feed.

The integrated activity indicator may further comprise a coaxial, twisted pair or other cable connecting an output of the high-frequency rectifier circuit to the LED. The integrated activity indicator may further comprise a resistor, coupled to the LED, configured to limit current to the LED (i.e. a current limiting resistor feeding the LED). The integrated activity indicator may further comprise a capacitor in parallel with the LED and configured to suppress broadband noise generated within the LED. The integrated activity indicator may further comprise an inductor in series with the resistor configured to limit current to the LED (i.e. the current limiting resistor).

In another exemplary embodiment, a method comprises feeding an antenna with RF energy, tapping a portion of the RF energy from the antenna while matching the impedance of the antenna by the use of a directional coupler, providing the portion to a high-frequency rectifier circuit, and supplying a LED with the portion from the high-frequency rectifier circuit. The method may further comprise suppressing broadband noise generated within the LED via a capacitor.

In yet another exemplary embodiment, a system comprises an antenna feed providing RF energy to an antenna, an impedance matching network coupled to the antenna feed and configured to tap a portion of RF energy from the antenna feed, a voltage doubler rectifier coupled to the impedance matching network, and a resistor coupled to the voltage doubler rectifier and supplying a LED. The impedance matching network may comprise a high impedance parallel connection at the antenna feed and a low output impedance that is matched to the voltage doubler rectifier that supply current to the LED.

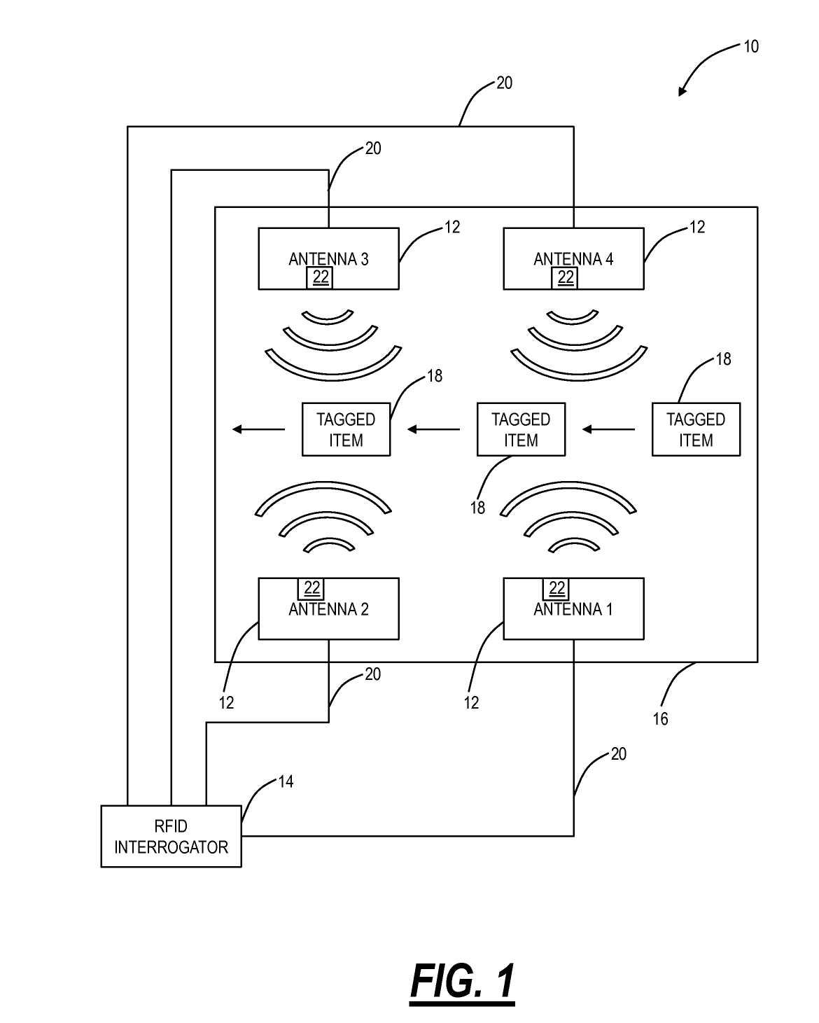

Referring to FIG. 1, in an exemplary embodiment, an installation is illustrated of a typical embodiment of an UHF RFID system 10. The RFID system 10 may comprise multiple fixed antennas 12 connected to one or more RFID interrogators 14. The RFID system 10 is designed to wirelessly monitor a choke point in a facility 16, such as a warehouse or factory, through which tagged items 18 pass and tracking data may be collected. Specifically, the tagged items 18 comprise RFID tags with information contained therein that is readable by the multiple fixed antennas 12. Optimum reliability of the system 10 is contingent on the correct operation of the interrogators 14, the antennas 12, and the integrity of cables 20 that connect them. FIG. 1 illustrates an exemplary embodiment with the four antennas 12 connected to the single interrogator 14 via the cables 20. Specifically, FIG. 1 illustrates an exemplary embodiment of the antennas 12 in an RFID application for illustration purposes, and those of ordinary skill in the art will recognize the present invention may be incorporated into any antenna application.

The facility 16 may comprise a “dock door” boundary in a warehouse or any other portal or choke point through with the tagged items 18 pass. Further, the facility 16 may be an industrial setting where the tendency is for the antennas 12, the interrogator 14, and/or the cables 20 to be “knocked around.” In this exemplary embodiment, the RFID system 10 comprises the RFID interrogator 14 that may be configured to energize the RFID antennas 12 via the cables 20 in a round-robin sequence to provide maximum coverage of the area and minimum probability of missed items. Thus, it is critical to ensure that the antennas 12 are operational.

When faults are suspected in the RFID system 10, a technician is typically summoned to check log files for messages that might indicate intermittent or hard antenna 12 failures. For various reasons, the RFID interrogators 14 cannot always reliably assess the integrity of the antennas 12, so the next step is usually to have the technician check the antenna connections and cables by whatever method seems appropriate, including substitution. Advantageously, the present invention provides a constant indication of correct antenna operation, largely bypassing the typical troubleshooting steps outlined above. The present invention may also facilitate and encourage monitoring of antenna operation in working installations by unskilled personnel, allowing faults to be detected promptly before they lead to significant amounts of corrupt data.

In this example, each of the four antennas 12 comprises an integrated indicator 22 that provides a visual indication of when the antenna 12 is transmitting RF energy. For example, the integrated activity indicator 22 may comprise a high-efficiency LED and passive circuitry configured to tap off a portion of RF energy from the antenna 12. This integrated activity indicator 22 may be incorporated within new or existing antenna designs, or added to existing antennas, as appropriate. It should be noted that no additional circuitry is required at the interrogator 14.

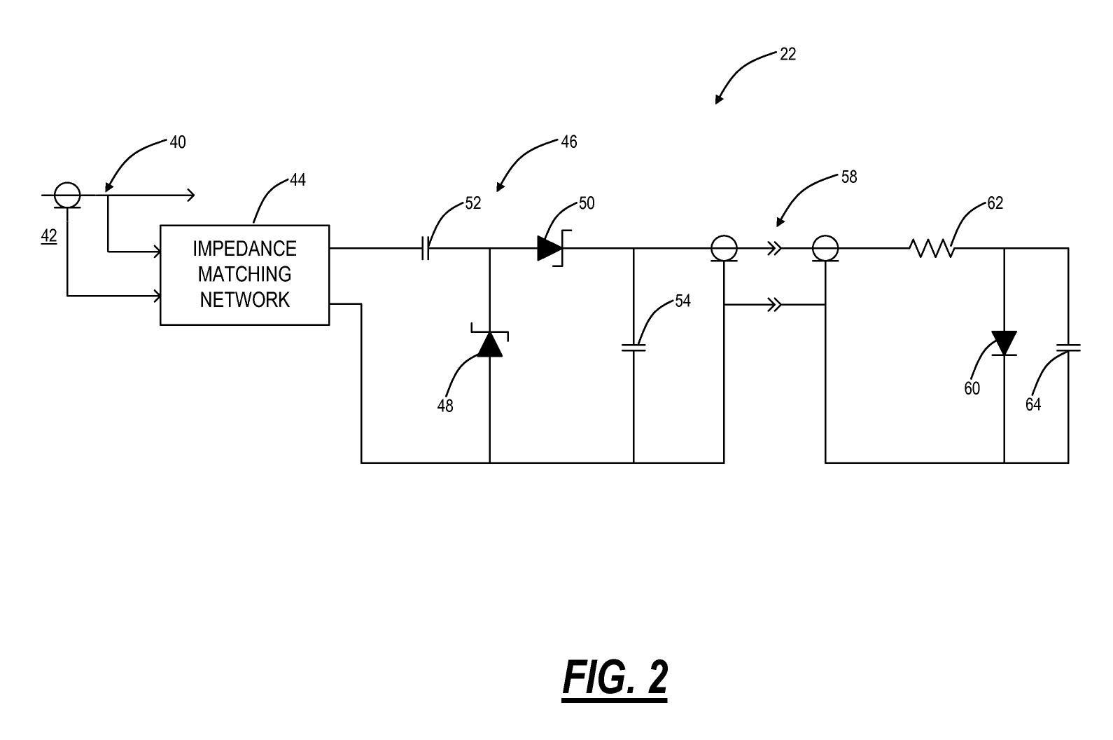

Referring to FIG. 2, a circuit diagram illustrates an exemplary implementation of the integrated activity indicator 22 in the antenna 12. In general, as mentioned above, the integrated activity indicator 22 is configured to tap a portion of RF energy from the antenna 12 and provide this RF energy to a high-efficiency LED. The integrated activity indicator 22 comprises a direct shunt connection 40 to an antenna feed 42. An impedance matching network 44 connects to the direct shunt connection 40.

The impedance matching network 44 is designed to provide a minimal load (at least 1 k-ohm) to the antenna feed 42 so as to have an insignificant effect on antenna operation. The purpose of the impedance matching network 44 is to tap off a small part of the RF energy being delivered to the antenna 12 without significantly disturbing antenna operation. The impedance matching network 44 may be implemented in various ways, including the use of a directional coupler. Alternatively, the impedance matching network 44 may comprise a simpler network using only passive components, such as inductors and capacitors. At an operating frequency, for example, 915 MHz, the impedance matching network 44 presents a high impedance parallel connection at the antenna feed 42 (which presents an insignificant disturbance to the antenna 12 and the interrogator 14) but has a low output impedance that is matched to rectifiers that supply DC current to an LED.

The output impedance of the impedance matching network 44 is significantly lower than its input and it couples directly into a high frequency rectifier circuit 46 formed by high-speed diodes 48, 50, such as Schottky diodes, and capacitors 52, 54 (e.g. 10 nF capacitors). In this exemplary embodiment, the high frequency rectifier circuit 46 is a voltage doubler rectifier. The various components 40, 42, 44, 46, 48, 50, 52, 54 are mounted on a circuit board (e.g. a printed circuit board (PCB)) in close proximity to the antenna feed 42 to control impedances and minimize losses. The high frequency rectifier circuit 46 outputs to a coaxial, twisted pair or other cable 58 that allows the remainder of the integrated activity indicator 22 to be physically remote from the antenna feed 42, e.g. at a point in a housing associated with the antenna 12.

The coaxial, twisted pair or other cable 58 connects to an LED portion that comprises a high efficiency LED 60 that is fed by a current limiting resistor 62 (e.g. 1 k-ohm) and a capacitor 64 (e.g. 10 nF) that suppresses broadband noise generated within the LED 60. The integrated activity indicator 22 is configured to illuminate the LED 60 based upon RF energy that is tapped from the antenna feed 42 via the impedance matching network 44 and the high frequency rectifier circuit 46.

The brightness of the LED 60 may be correlated to the RF energy to the antenna 12. Although the requirement that the integrated activity indicator 22 present minimal loading to the antenna 12, this requirement will necessarily limit the energy transferred to the LED 60, and hence its brightness. However, recent improvements have resulted in LEDs that are clearly visible indoors at currents in the range of 1-2 mA, and it is expected that the indicator will operate usefully down to antenna power levels of at least 24 dBm and possibly lower.

Furthermore, the addition of the integrated activity indicator 22 in the antenna 12 may result in locally generated noise that could compromise performance. This noise is expected to be broadband in nature and mainly generated by the LED 60 and the high frequency rectifier circuit 46. Care will need to be taken to ensure that only minimal noise, e.g. that is expected to be broadband in nature and mainly generated by the LED 60 and rectifier circuit 46, is coupled back into the antenna 12 from where it could eventually appear as in-band demodulation products within the receiver. It is not yet known if this will be a problem in practice but, if noise generated by the LED 60 is an issue, it could be addressed by low-pass filtering between the high frequency rectifier circuit 46 and the LED 60. The capacitor 64 is part of that filtering and an inductor could be added in series with resistor 62 to further reduce high frequency noise being coupled back towards the antenna. If significant noise is generated by the rectifier diodes, this could be more difficult to eradicate and might require the inclusion of a matching network with a high-Q bandpass characteristic, and tuned to the frequency of operation.

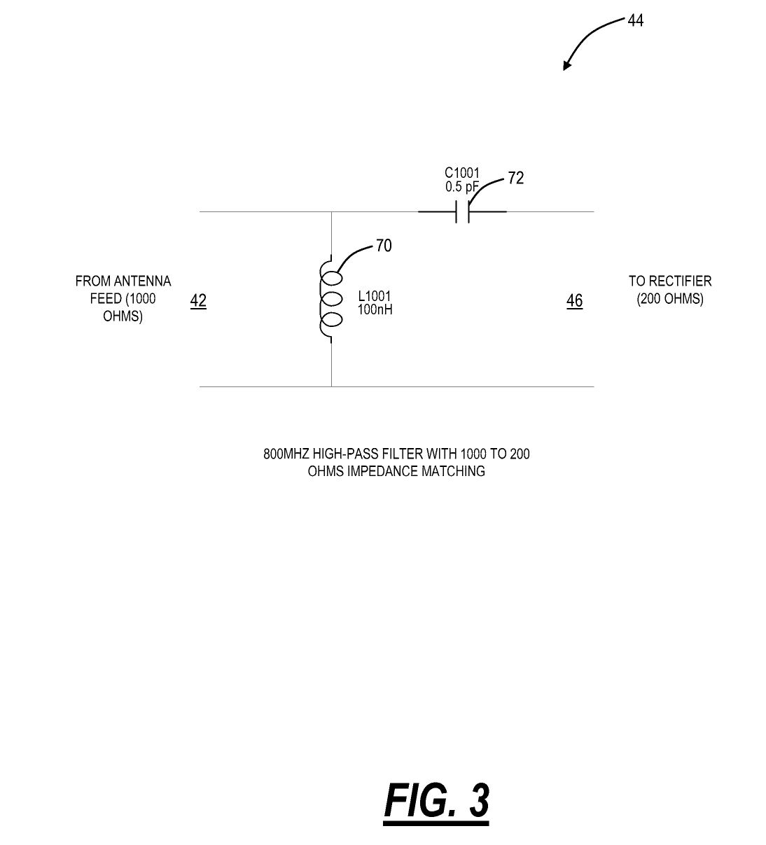

Referring to FIG. 3, in an exemplary embodiment, an exemplary implementation of the impedance matching network 44 is illustrated which also performs a high-pass filtering function, favoring spectral components above 800 MHz. More sophisticated impedance matching networks 44 using inductors and capacitors may also be constructed, and an example would be a network with a bandpass frequency characteristic. In this case, the impedance matching network 44 would typically be expanded to a plurality of inductors and capacitors. In general, however, impedance matching networks typically comprise suitably sized inductors and capacitors appropriately interconnected. In this example of FIG. 3, the impedance matching network 44 comprises an inductor 70 and a capacitor 72. For example, the inductor 70 may be 100 nH and the capacitor 72 may be 0.5 pF, presenting a load of 1000 ohms at the antenna feed 42 and a 200 ohm source to the high frequency rectifier circuit 46.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An antenna having an integrated activity indicator, wherein the antenna has an antenna feed, the integrated activity indicator comprising:
an impedance matching network coupled to the antenna feed and configured to tap a portion of radio frequency energy from the antenna feed;
a high-frequency rectifier circuit coupled to the impedance matching network; and
a light emitting diode coupled to an output of the high-frequency rectifier circuit.

2. The integrated activity indicator of claim 1, wherein the impedance matching network comprises a high impedance parallel connection at the antenna feed, and a low output impedance that is matched to a voltage doubler rectifier that supplies current to the light emitting diode.

3. The integrated activity indicator of claim 2, wherein the impedance matching network comprises a directional coupler.

4. The integrated activity indicator of claim 2, wherein the impedance matching network comprises inductors and capacitors.

5. The integrated activity indicator of claim 2, wherein the impedance matching network comprises an inductor in parallel to the antenna feed and a capacitor connected to the high-frequency rectifier circuit.

6. The integrated activity indicator of claim 1, further comprising a cable connecting an output of the high-frequency rectifier circuit to the light emitting diode.

7. The integrated activity indicator of claim 6, wherein the impedance matching network and the high-frequency rectifier circuit are disposed on a circuit board in a vicinity of the antenna feed, and wherein the light emitting diode is physically remote from the antenna feed.

8. The integrated activity indicator of claim 1, further comprising a resistor, coupled to the light emitting diode, configured to limit current to the light emitting diode.

9. The integrated activity indicator of claim 8, further comprising a capacitor, in parallel with the light emitting diode, configured to suppress broadband noise generated within the light emitting diode.

10. The integrated activity indicator of claim 9, further comprising an inductor in series with the resistor configured to limit current to the light emitting diode.

11. A method, comprising:
feeding an antenna with radio frequency energy;
tapping a portion of the radio frequency energy (RF) from the antenna using a matching network with high input impedance;
providing the portion of the RF energy from the antenna to a high-frequency rectifier circuit; and
supplying a light emitting diode with the portion of the RF energy from the high-frequency rectifier circuit.

12. The method of claim 11, further comprising suppressing broadband noise generated within the light emitting diode via a capacitor.

13. The method of claim 13, further comprising limiting current to the light emitting diode via a resistor.
